(19) United States
(12) Patent Application Publication
(10) Pub. No.: US 2024/0347933 A1
(43) Pub. Date: Oct. 17, 2024

(54) CONNECTOR

(71) Applicant: Yazaki Corporation, Tokyo (JP)

(72) Inventors: Hirohito NAKATA, Shizuoka (JP); Ryosuke HARA, Shizuoka (JP)

(73) Assignee: Yazaki Corporation, Tokyo (JP)

(21) Appl. No.: 18/626,610

(22) Filed: Apr. 4, 2024

(30) Foreign Application Priority Data
Apr. 17, 2023 (JP) 2023-067014
Sep. 12, 2023 (JP) 2023-147430
Nov. 13, 2023 (JP) 2023-193000

(51) Int. Cl. H01R 4/02; H01R 13/502

(52) U.S. Cl. CPC H01R 4/023; H01R 13/502

(57) ABSTRACT

Provided is a connector including: two inner terminals each including a joining part; and an inner housing including two parallel through holes for accommodating the two inner terminals one by one in a same orientation. The joining part includes at least a bottom wall part that includes a joining surface. A width of the bottom wall part is set larger than a dimension value of the width when a distance from a center of a core wire to a maximum distance part which is the farthest from the core wire at the joining part, and a maximum cross-sectional radius of the through hole are a same value. The core wire is joined to the joining surface using laser welding or laser soldering.

### CROSS-REFERENCE TO RELATED APPLICATION

The present application is based on, and claims priority from the Japanese Patent Applications No. 2023-067014, filed on Apr. 17, 2023, No. 2023-147430, filed on Sep. 12, 2023 and No. 2023-193000, filed on Nov. 13, 2023, the entire contents of which are incorporated herein by reference.

### TECHNICAL FIELD

The disclosure relates to a connector.

### BACKGROUND

Conventionally, there is a communication connector in which a terminal metal fitting connected to an electric wire is accommodated in a housing. WO 2010/150684 A1 focuses on a crimp terminal as a terminal metal fitting and discloses a technique for an evaluation method for a crimping part, in which the crimp-height (C/H) or crimp-width (C/W) of the dimensions of the crimping part affects the quality of crimping. In conventional communication connectors, as discussed in WO 2010/150684 A1, crimp terminals are often adopted as terminal metal fittings.

### SUMMARY OF THE INVENTION

For example, assuming a connector which is connected to a twisted-pair wire and capable of supporting current or future high-speed communication standards, it may also become difficult to ensure transmission performance when a crimp terminal is adopted as a terminal metal fitting. The crimp terminal has a wire barrel for fastening the core wire, and the crimp-height or crimp-width at the crimping part, which is the part where the core wire is crimped to the wire barrel, has an acceptable range related to transmission performance. Therefore, it is not easy to modify the shape of the wire barrel at the crimp terminal in order to ensure transmission performance that can support high-speed communication standards, because it is actually subject to restrictions based on the above acceptable range.

An object of the present disclosure is to provide a connector that improves transmission performance.

A connector according to some embodiments includes: two terminal metal fittings each including a joining part for joining either one of core wires of two wires included in one electric wire, and an insulating member including two parallel through holes for accommodating the two terminal metal fittings one by one in a same orientation, wherein the joining part includes at least a bottom wall part that has a plate shape and includes a joining surface for joining the core wire thereto while in contact with a side part of the core wire, a width of the bottom wall part in a width direction orthogonal to an extension direction of the terminal metal fitting is set larger than a dimension value of the width when a distance from a center of the core wire to a maximum distance part which is the farthest from the core wire at the joining part, and a maximum cross-sectional radius of the through hole are a same value, and the core wire is joined to the joining surface using laser welding or laser soldering.

According to the above configuration, it is possible to provide a connector that improves transmission performance.

### BRIEF DESCRIPTION OF DRAWINGS

FIG. 1 is a perspective view of a connector according to a first embodiment, which is connected to an electric wire.

FIG. 2 is an exploded perspective view of the connector according to the first embodiment.

FIG. 3 is a perspective view of the connector before attaching an outer housing.

FIG. 4 is a diagram illustrating joining of a core wire to an inner terminal in the first embodiment.

FIG. 5 is a cross-sectional view of the connector corresponding to the V-V section in FIG. 3.

FIG. 6 is a diagram illustrating joining of a core wire to an inner terminal in a second embodiment.

FIG. 7 is a cross-sectional view of a connector according to the second embodiment.

FIG. 8 is a cross-sectional view of a connector according to a third embodiment.

FIG. 9A is a perspective view of an inner terminal in a fourth embodiment.

FIG. 9B is a rear view of the inner terminal in the fourth embodiment.

FIG. 10 is a cross-sectional view of a connector according to the fourth embodiment.

FIG. 11A is a perspective view of another inner terminal in the fourth embodiment.

FIG. 11B is a rear view of the other inner terminal in the fourth embodiment.

FIG. 12A is a perspective view of an inner terminal in a fifth embodiment.

FIG. 12B is a rear view of the inner terminal in the fifth embodiment.

FIG. 13 is a cross-sectional view of a connector according to the fifth embodiment.

### DETAILED DESCRIPTION OF THE INVENTION

Referring to the drawings, detailed descriptions are given below of connectors according to embodiments. Note that dimensional ratios in the drawings are exaggerated for convenience of descriptions and are sometimes different from actual ratios.

### First Embodiment

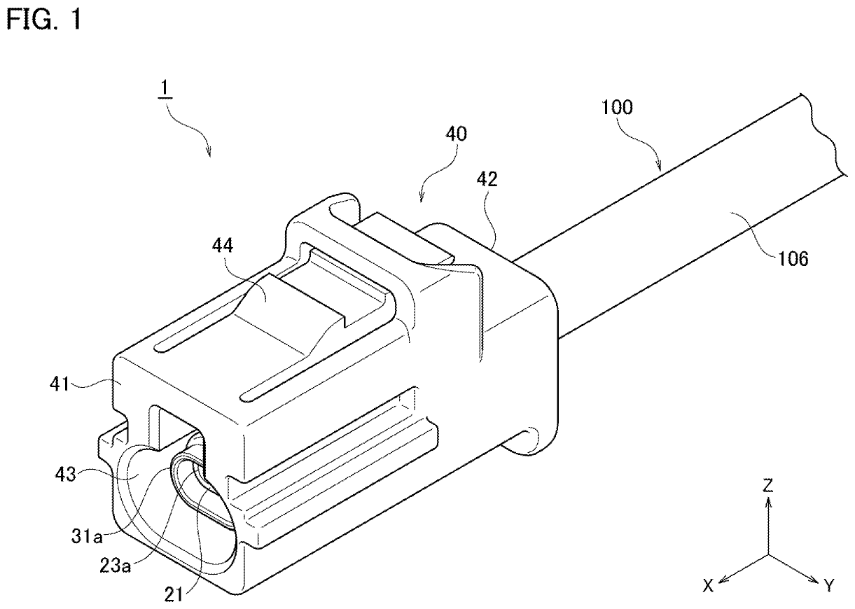

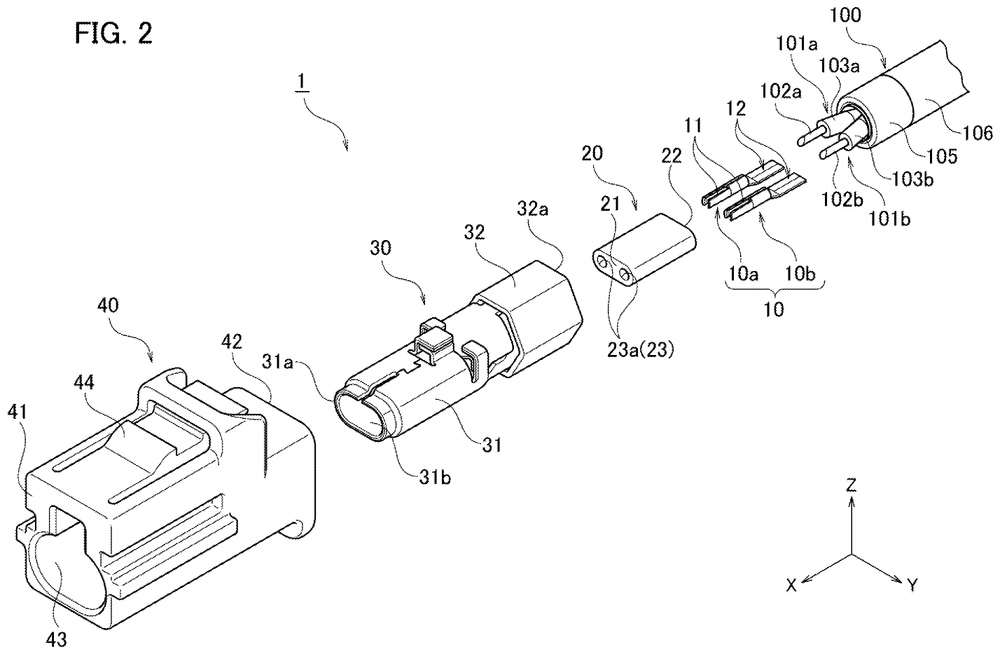

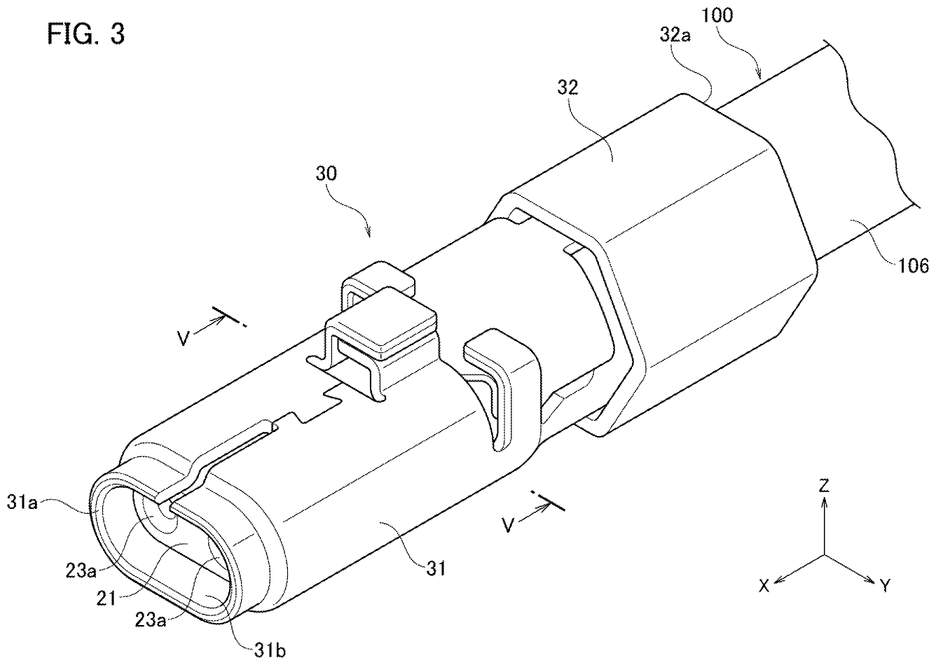

FIG. 1 is a perspective view of a connector 1 according to the first embodiment. FIG. 1 illustrates the connector 1 connected to an electric wire 100. FIG. 2 is an exploded perspective view of the connector 1. FIG. 3 is a perspective view of the connector 1 before attaching an outer housing 40.

Respective directions referred to in order to describe the structure of the connector 1 are defined below as follows. The X direction corresponds to the connection direction when the connector 1 is connected to an external connection object. The X direction also corresponds to the extension direction and the length direction of inner terminals 10 as terminal metal fittings accommodated inside the connector 1. A transverse section at each position regarding each of the elements constituting the connector 1 and the electric wire 100 is represented by the YZ plane defined by the Y direction and the Z direction which are perpendicular to the X direction and perpendicular to each other. The Y direction corresponds to the width direction regarding the inner terminals 10. The Z direction corresponds to the height direction regarding the inner terminals 10.

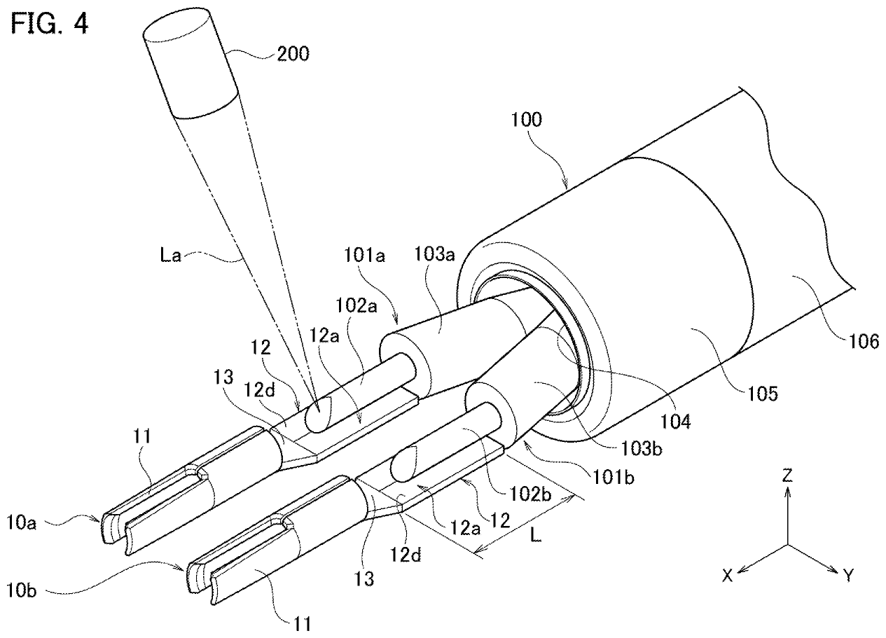

The connector 1 is attached to, for example, an on-vehicle electric wire and realizes high-speed digital signal transmission in a high-speed region and a high-frequency band, supporting current or future high-speed communication standards. In the present embodiment, the electric wire 100 to which the connector 1 is attached includes two wires therein, a first wire 101a and a second wire 101b, as differential wires. Specifically, the electric wire 100 may be a shielded twisted pair (STP) or a shielded parallel pair (SPP). The first wire 101a includes a first core wire 102a, which is a conductor, and a first insulator 103a covering the first core wire 102a. Similarly, the second wire 101b includes a second core wire 102b, which is a conductor, and a second insulator 103b covering the second core wire 102b. The electric wire 100 also includes a presser winding 104 (see FIG. 4) for winding the first wire 101a and the second wire 101b as one body, a conductive shield 105 covering the outer periphery of the presser winding 104, and an insulating sheath 106 covering the outer periphery of the shield 105.

The connector 1 also includes two inner terminals 10, an inner housing 20, an outer terminal 30, and the outer housing 40.

FIG. 4 is a diagram illustrating joining of the first core wire 102a to a joining part 12 of a first terminal 10a as an example of joining of a core wire to an inner terminal 10.

The inner terminals 10 are each a terminal metal fitting which functions as a signal line conductor. The connector 1 includes two inner terminals 10, the first terminal 10a and a second terminal 10b. The first terminal 10a is attached to the tip of the first wire 101a. The second terminal 10b is attached to the tip of the second wire 101b. The shapes of the first terminal 10a and the second terminal 10b are identical to each other. Each of the inner terminals 10 has a connecting part 11, the joining part 12, and a coupling part 13.

When the connector 1 is connected to an external connection object, the connecting part 11 receives insertion of a counterpart signal terminal metal fitting. The connecting part 11 is cylindrical in the axial direction along the length direction. A part of the open end of the connecting part 11 is constituted by a pair of elastic contact pieces.

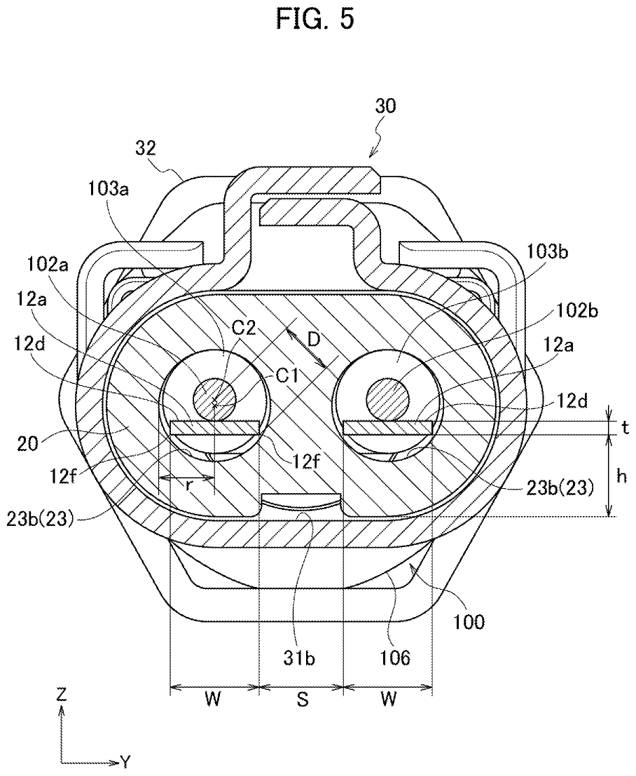

The joining part 12 is for joining the first core wire 102a or the second core wire 102b thereto. The joining part 12 of the first terminal 10a is for joining the first core wire 102a of the first wire 101a thereto. The joining part 12 of the second terminal 10b is for joining the second core wire 102b of the second wire 101b thereto. In the present embodiment, the joining part 12 is constituted by only a bottom wall part 12a having a flat plate shape. The bottom wall part 12a is defined to have the dimension in the length direction as a length L, the dimension in the width direction as a width W (see FIG. 5), and the dimension in the height direction as a height t (see FIG. 5). The bottom wall part 12a has a joining surface 12d which is one main flat surface along the XY plane. The first core wire 102a and the second core wire 102b are joined to the joining surfaces 12d each corresponding to the core wires using laser welding or laser solder, with the side parts of the core wires to be joined in contact therewith. FIG. 4 illustrates, as an example, the first core wire 102a joined to the joining surface 12d of the first terminal 10a through laser welding using a laser beam La irradiated from a laser head 200. Note that conditions related to the dimensions of each part of the bottom wall part 12a will be described in detail below.

The coupling part 13 is located between the connecting part 11 and the joining part 12 along the length direction, and couples the connecting part 11 and the joining part 12. In the present embodiment, the outer diameter of the connecting part 11 having a cylindrical shape is set smaller than the width W of the bottom wall part 12a, and thus a part of the coupling part 13 is formed in a tapered shape.

The inner housing 20 is an insulating member for matching the impedance between the first wire 101a and the second wire 101b. The material of the inner housing 20 is, for example, a synthetic resin. The inner housing 20 has two parallel through holes 23 for accommodating the two inner terminals 10 one by one in the same orientation. Note that the through holes 23 here may be referred to as cavities. The inner housing 20 has the length direction as the longitudinal direction in order to accommodate the entire inner terminals 10 in the through holes 23. The transverse-sectional shape of the inner housing 20 is approximately oval in such a manner that the thickness of the outer peripheral part is equally ensured with respect to each of the two through holes 23.

In accordance with the shape of the inner terminal 10, each through hole 23 coaxially includes a tip hole 23a for accommodating the connecting part 11 and a root hole 23b (see FIG. 5) for accommodating the joining part 12 and the coupling part 13. The tip hole 23a is opened to the outside from a first end surface 21 which is an end surface on the tip side of the inner housing 20. The root hole 23b is opened to the outside from a second end surface 22 which is an end surface on the root side of the inner housing 20. When the connector 1 is assembled, the inner terminal 10 is inserted into the through hole 23 from the second end face 22 side. Here, since the tip hole 23a has an inner diameter sufficient to accommodate the connecting part 11, while the root hole 23b has an inner diameter sufficient to accommodate the joining part 12, the inner diameter of the root hole 23b is larger than that of the tip hole 23a. Therefore, in the present embodiment, the maximum cross-sectional radius of the through hole 23 corresponds to a cross-sectional radius r of the root hole 23b (see FIG. 5).

The outer terminal 30 is a terminal metal fitting which functions as a shield conductor. The outer terminal 30 includes a shield connecting part 31 and a shield barrel part 32.

When the connector 1 is connected to an external connection object, the shield connecting part 31 is engaged with a corresponding terminal metal fitting for shielding. The shield connecting part 31 has the axial direction along the length direction, and a cylindrical shape whose transverse section is roughly oval in accordance with the outer shape of the inner housing 20. The shield connecting part 31 accommodates, in the inner space surrounded by an inner peripheral surface 31b, the inner housing 20 with the inner terminals 10 accommodated in the through holes 23. A connection port 31a of the shield connecting part 31 causes the first end surface 21 of the inner housing 20 to be opened outward.

The shield barrel part 32 engages with the shield 105 of the electric wire 100 with the tip of the electric wire 100 inserted from a wire introduction port 32a and the shield connecting part 31 accommodating the inner housing 20. That is, the shield barrel part 32 has a cylindrical shape coaxially connected to the shield connecting part 31.

The outer housing 40 is an insulating member which forms the exterior of the connector 1. The material of the outer housing 40 is, for example, a synthetic resin. The outer housing 40 has a cylindrical shape with an axial direction along the length direction and a substantially rectangular transverse section. The outer housing 40 has an accommodating part 43 which penetrates along the axial direction between a tip surface 41 and an electric wire connection surface 42. The accommodating part 43 accommodates the inner terminals 10, the inner housing 20, and the outer terminal 30, which are prepared as a unit illustrated in FIG. 3. Note that the accommodating part 43 may also be referred to as a cavity. In the connector 1 in the completed state, as illustrated in FIG. 1, an opening on the tip surface 41 side of the accommodating part 43 causes the first end surface 21 of the inner housing 20 and the connection port 31a of the shield connecting part 31 to be opened outward. The outer housing 40 may also have, on a part of its outer wall surface, an engagement part 44 which engages, when the connector 1 is connected to an external connection object, with an engagement part pre-provided on the connection object. The engagement part 44 functions as what is called a lock mechanism for preventing the dropping of the connector 1 from the connection object.

Next, a possible shape of the joining part 12 in the inner terminal 10 will be described in detail.

FIG. 5 is a cross-sectional view of the connector 1, which corresponds to the V-V section in FIG. 3 and is cut in a transverse section where the first core wire 102a and the second core wire 102b each joined to either one of the joining parts 12 of the inner terminals 10 are present.

The joining part 12 of the inner terminal 10 is the bottom wall part 12a having a flat plate shape as described above. The transverse section of the bottom wall part 12a is a rectangle defined by the width W and the height t. Note that the height t may correspond to the thickness of the bottom wall part 12a. Here, in the transverse section illustrated in FIG. 5, attention is focused on the bottom wall part 12a to which the first wire 101a, which is one wire, is joined. At this time, the distance from a center C2 of the first core wire 102a to a maximum distance part 12f which is the farthest from the first core wire 102a in the bottom wall part 12a is defined as a distance D. Note that one bottom wall part 12a has two maximum distance parts 12f. Meanwhile, in the inner housing 20, the maximum cross-sectional radius of the through hole 23 in which the joining part 12 is accommodated is the cross-sectional radius r of the root hole 23b as described above.

In the present embodiment, the width W of the bottom wall part 12a is set larger than the dimension value of the width W when the distance D and the cross-sectional radius r of the root hole 23b are the same value. Here, it is assumed that the bottom wall part 12a is accommodated in the root hole 23b in such a manner that the center C2 of the first core wire 102a coincides with the center C1 of the through hole 23. In this case, when the distance D and the cross-sectional radius r are the same value, the two maximum distance parts 12f comes into contact with the inner wall surface forming the root hole 23b in the inner housing 20. However, in practice, as illustrated in FIG. 5, the center C2 of the first core wire 102a does not necessarily coincide with the center C1 of the through hole 23, and a deviation from the center C1 of the through hole 23 is permitted. Thus, even when the width W is set larger than the dimension value when the distance D and the cross-sectional radius r are the same value, the bottom wall part 12a can be accommodated in the root hole 23b as long as it is not larger than the maximum set dimension of the width W. Therefore, the width W can be set larger on the premise that the bottom wall part 12a is accommodated in the root hole 23b. The maximum set dimension of the width W is the maximum value to the extent that the accommodation of the bottom wall part 12a in the root hole 23b is permitted.

In contrast, the height t of the bottom wall part 12a can be derived by considering the diameter of the first core wire 102a in addition to the above setting of the width W. Note that although attention is focused on the bottom wall part 12a for joining the first wire 101a, the bottom wall part 12a for joining the second wire 101b, which is the other wire, is similarly set.

Next, the effect of the connector 1 will be described.

First, the connector 1 is provided with two terminal metal fittings each having a joining part 12 for joining a core wire of each of two wires included in one wire 100, that is, either one of the first core wire 102a of the first wire 101a or the second core wire 102b of the second wire 101b. Further, the connector 1 includes an insulating member having two parallel through holes 23 for accommodating the two terminal metal fittings one by one in the same orientation. The joining part 12 includes at least the bottom wall part 12a which has a flat plate shape and includes the joining surface 12d for joining the core wire thereto while in contact with the side part of the core wire. The width W of the bottom wall part 12a in the width direction orthogonal to the extension direction of the terminal metal fitting is set larger than the dimension value of the width W when the distance D and the maximum cross-sectional radius of the through hole 23 are the same value. The distance D is a distance from the center C2 of the core wire to the maximum distance part 12f which is the farthest from the core wire at the joining part 12. The core wire is joined to the joining surface 12d using laser welding or laser solder.

In the connector 1, the bottom wall part 12a may be a flat plate part.

Here, in the above example, the terminal metal fitting having the joining part 12 corresponds to the inner terminal 10, and the two terminal metal fittings correspond to the first terminal 10a and the second terminal 10b. The insulating member having the two parallel through holes 23 corresponds to the inner housing 20 in the above example. Since the through hole 23 is a part which accommodates one terminal metal fitting, the maximum cross-sectional radius of the through hole actually corresponds to the cross-sectional radius r of the root hole 23b illustrated in the above example as the part where the joining part 12 is accommodated. Further, the extension direction of the terminal metal fitting corresponds to the X direction in the above example, and the width direction of the terminal metal fitting corresponds to the Y direction in the above example.

Generally, an impedance calculation formula for a microstrip line as an exterior wire of a printed wire board (hereinafter referred to as “microstrip line formula”) is known. Specifically, the microstrip line formula is expressed using the following formulas (1) and (2).

$$\begin{matrix}[ Math . 1 ] & \\ {Z}_{0} = \frac{60}{\sqrt{0.475 {ε}_{r} + 0.67}} ln [ \frac{4 h}{0.67 ( 0.8 W + t )} ] & ( 1 )\end{matrix}$$

$$\begin{matrix}[ Math . 2 ] & \\ {Z}_{diff} = 2 {Z}_{0} ( 1 - 0.48 {e}^{- 0.96 \frac{S}{h}} ) & ( 2 )\end{matrix}$$

Note that Z₀ is the characteristic impedance of a wire (conductor). εᵣ is the relative permittivity of an insulating layer (dielectric). “h” is the thickness of the insulating layer. “W” is the width of the wire. “t” is the thickness of the wire. Z_{diff} is the differential impedance. “S” is the distance between the wires.

Here, the first terminal 10a and the second terminal 10b are arranged in the same orientation and in parallel with each other inside the inner housing 20 of the connector 1. The joining parts 12 accommodated in the two root holes 23b are each the bottom wall part 12a having a flat plate shape. Thus, each shape and arrangement of the two bottom wall parts 12a in the inner housing 20 as illustrated in FIG. 5 can be applied to the microstrip line formula in the following correspondence. For “W” in formula (1), the width W of the bottom wall part 12a can be applied. For εᵣ in formula (1), the relative dielectric constant of the insulating material forming the inner housing 20 can be applied. For “h” in formulas (1) and (2), the thickness h from the surface opposite to the joining surface 12d at the bottom wall part 12a to the immediate outer surface of the inner housing 20 along the height direction can be applied. For “t” in formula (1), the height t corresponding to the thickness of the bottom wall part 12a can be applied. For “S” in formula (2), the spacing S between the bottom wall parts 12a can be applied.

In the microstrip line formula to which the configuration of the connector 1 is applied, the value of the characteristic impedance Z₀ indicated by formula (1) becomes smaller as the width W of the bottom wall part 12a is set larger. In addition, the value of the differential impedance Z_{diff} indicated by formula (2) becomes smaller as the value of the characteristic impedance Z₀ becomes smaller.

In the connector 1, since the width W of the bottom wall part 12a is set larger than the dimension value of the width W when the distance D and the cross-sectional radius r of the root hole 23b are the same value, the value of the characteristic impedance Z₀ and consequently the value of the differential impedance Z_{diff} can be made smaller. Thus, the connector 1 can improve the transmission performance in order to suppress the increase in impedance and secure the transmission performance which can support high-speed communication standards.

Note that as a comparative example, in a connector in which each core wire of twisted-pair wires is attached to a crimp terminal, it is difficult to significantly change the shape of the wire barrel due to restrictions on crimp-height or crimp-width. That is, it is practically difficult to suppress the increase in impedance by changing the shape of the wire barrel.

In the connector 1, since the core wire is joined to the joining surface 12d using laser welding or laser solder, even when the shape of the bottom wall part 12a is a flat plate shape, there is no issue in joining the core wire to the inner terminal 10. In other words, by joining the core wire to the joining surface 12d using laser welding or laser solder, the shape of the bottom wall part 12a can be made into a flat plate shape whose width can be set larger.

As described above, the present embodiment can provide the connector 1 that improves transmission performance.

In addition, in the connector 1, the width W of the bottom wall part 12a may be set to the maximum value to the extent that the accommodation of the joining part 12 in the through hole 23 is permitted.

In this connector 1, the value of the width W of the bottom wall part 12a is set to the largest value that can be set in the structure, thereby achieving higher transmission performance.

### Second Embodiment

In the first embodiment, the case is exemplified where the joining part 12 in the inner terminal 10 is the bottom wall part 12a having a flat plate shape. In contrast, a connector 1 according to the second embodiment adopts instead of the inner terminal 10 an inner terminal 50 in which the shape of the joining part 12 is modified.

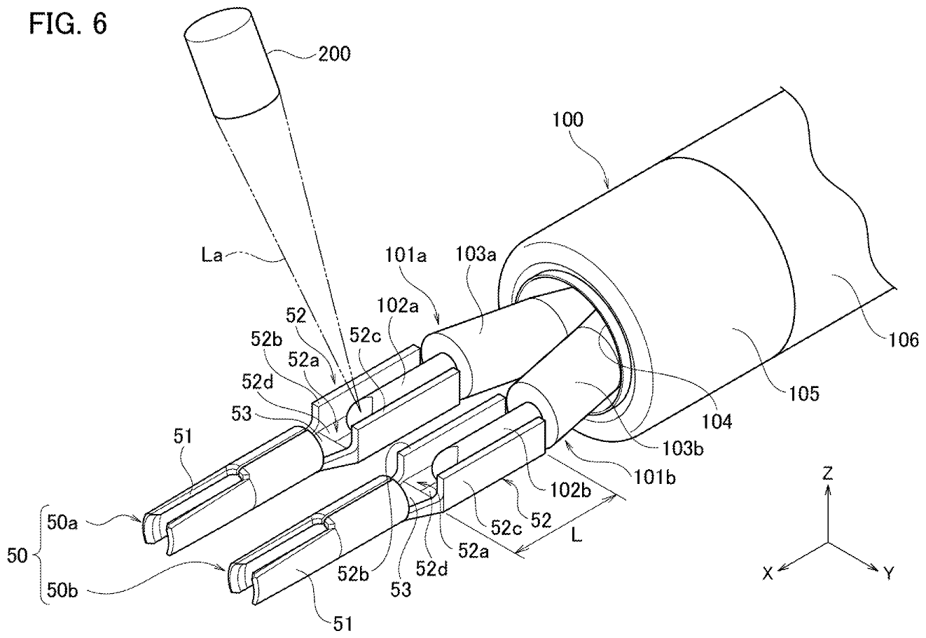

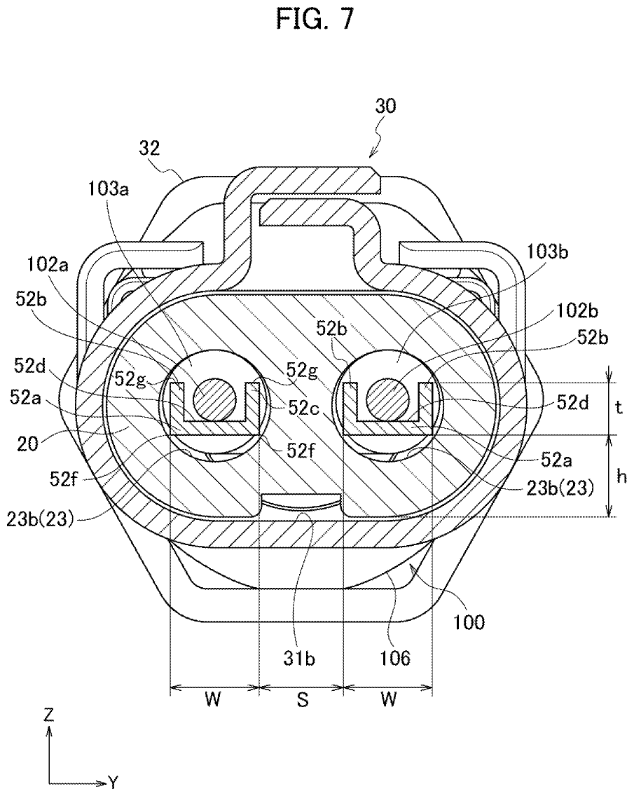

FIG. 6 is a diagram illustrating the joining of a first core wire 102a to a joining part 52 of a first terminal 50a as an example of joining of a core wire to the inner terminal 50 in the second embodiment. FIG. 7 is a cross-sectional view of the connector 1 cut in a transverse section where the first core wire 102a and a second core wire 102b each joined to either one of the joining parts 52 of the inner terminals 50 are present. Note that FIG. 6 is drawn corresponding to FIG. 4 regarding the first embodiment. FIG. 7 is drawn corresponding to FIG. 5 regarding the first embodiment. In the second embodiment, the same elements as those used in the description of the first embodiment are denoted by the same reference numerals, and the detailed description thereof will be omitted.

As in the first embodiment, in the connector 1 according to the present embodiment, there are two inner terminals 50, the first terminal 50a and a second terminal 50b. The inner terminal 50 includes a connecting part 51, the joining part 52, and a coupling part 53. In the inner terminal 50, the shape of the joining part 52 and the shape of the coupling part 53 associated with the shape of the joining part 52 differ from the shapes of the joining part 12 and the coupling part 13 in the first embodiment. The shape of the connecting part 51 is the same as that of the connecting part 11 in the first embodiment.

The joining part 52 includes a bottom wall part 52a, a first side wall part 52b, and a second side wall part 52c. The bottom wall part 52a corresponds to the bottom wall part 12a in the first embodiment. The first side wall part 52b projects from one end in the width direction of the bottom wall part 52a in the height direction perpendicular to a joining surface 52d. The second side wall part 52c projects from the other end in the width direction of the bottom wall part 52a in the height direction perpendicular to the joining surface 52d. The first side wall part 52b and the second side wall part 52c have the same flat plate shape and are opposed to each other in the width direction. Here, the height of the joining part 52 in the height direction can be regarded as the maximum height t from the bottom wall part 52a to a tip part 52g of the first side wall part 52b or the second side wall part 52c. Note that the thicknesses in the width direction of the first side wall part 52b and the second side wall part 52c may be each equal to, for example, the thickness in the height direction of the bottom wall part 52a.

As in the first embodiment, for example, the distance from the center C2 of the first core wire 102a to a maximum distance part 52f which is the farthest from the first core wire 102a at the joining part 52 can be defined as a distance D. The width W of the bottom wall part 52a is set larger than the dimension value of the width W when the distance D and the cross-sectional radius r of a root hole 23b are the same value.

In this manner, in the connector 1 according to the second embodiment, the joining part 52 may include two side wall parts each having a flat plate shape and projecting from both ends in the width direction of the bottom wall part 52a in the height direction perpendicular to the joining surface 52d.

Here, the two side wall parts included in the joining part 52 correspond to the first side wall part 52b and the second side wall part 52c in the above example.

In this connector 1, first, the width W of the bottom wall part 52a of the joining part 52 is set in the same manner as in the first embodiment, and thus the transmission performance can be improved.

In addition, the joining part 52 is provided with two side wall parts, and thus the height of the joining part 52 can be set as high as the maximum height t. Here, as in the description regarding the first embodiment, referring to the microstrip line formula, for “t” in formula (1), the maximum height t corresponding to the height of the first side wall part 52b or the second side wall part 52c can be applied. At this time, in the microstrip line formula to which the configuration of the connector 1 according to the present embodiment is applied, the value of the characteristic impedance Z₀ indicated by the formula (1) becomes smaller as the maximum height t is set larger. Further, as the value of the characteristic impedance Z₀ becomes smaller, the value of the differential impedance Z_{diff} indicated by the formula (2) also becomes smaller. Therefore, the connector 1 can suppress the increase in impedance and improve transmission performance.

Further, since two side wall parts are provided in the joining part 52, a core wire such as the first core wire 102a to be joined to the joining surface 52d is arranged on the joining surface 52d so as to be sandwiched between these two side wall parts. Here, in the connector 1, the core wire is joined to the joining surface 52d using laser welding or laser solder, which can join a narrower range than when other joining methods are adopted. Thus, even when the core wire is arranged on the joining surface 52d so as to be sandwiched between the two side wall parts, there is no issue in joining the core wire to the inner terminal 50. In other words, by joining the core wire to the joining surface 52d using laser welding or laser solder, the shape of the joining part 52 can be made to have two side wall parts.

In the connector 1 according to the second embodiment, the maximum height t of the joining part 52 in the height direction may be set to the maximum value to the extent that the accommodation of the joining part 52 in a through hole 23 is permitted.

In this connector 1, the value of the maximum height t of the joining part 52 is set to the largest value that can be set in the structure, thereby achieving higher transmission performance.

Furthermore, in the connector 1 according to the second embodiment, in the extension direction of the inner terminal 50 as the terminal metal fitting, the length L of the side wall parts may be the same as the length of the bottom wall part 52a.

In this connector 1, the side wall parts can be set larger at the joining part 52, and the shape of the terminal metal fitting can be easily maintained constant when the terminal metal fitting is manufactured, which can be advantageous to stabilize the impedance value for each manufactured terminal metal fitting.

### Third Embodiment

Each of the above embodiments exemplifies the case where in the inner housing 20, the transverse-sectional shape of the root hole 23b accommodating the joining part 12 or the joining part 52 is a circle defined by the maximum cross-sectional radius r. In contrast, in a connector 1 according to the third embodiment, the shape of a root hole 23b in a through hole 23 is modified from the case where the transverse-sectional shape is a circle, assuming that an inner terminal 50 having a first side wall 52b and a second side wall 52c provided in a joining part 52 is adopted.

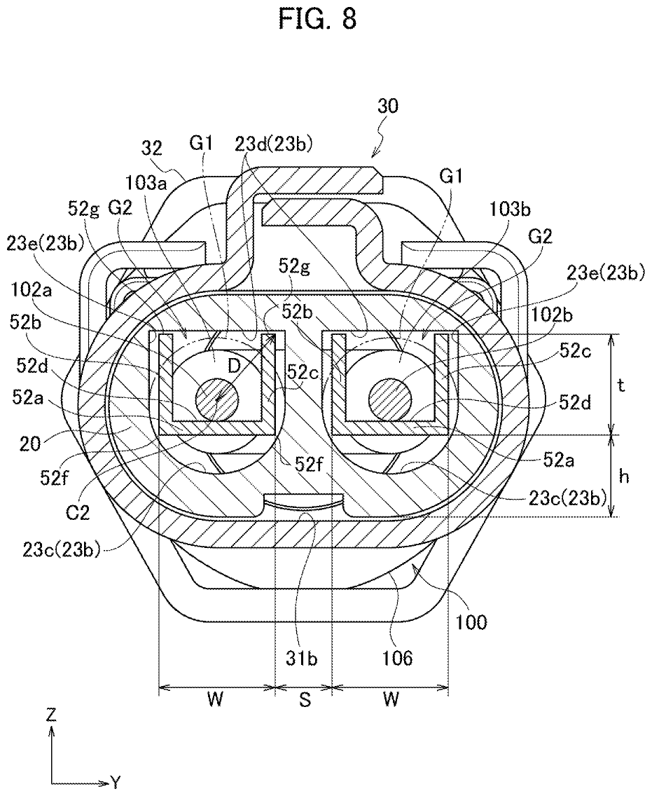

FIG. 8 is a cross-sectional view of the connector 1 according to the third embodiment, which is cut in a transverse section where a first core wire 102a and a second core wire 102b each joined to either one of the joining parts 52 of the inner terminals 50 are present. Note that FIG. 8 is drawn corresponding to FIG. 7 regarding the second embodiment. In the third embodiment, elements corresponding to the elements used in the description of the second embodiment are denoted by the same reference numerals, and the detailed description thereof may be omitted as appropriate.

In an inner housing 20 of the present embodiment, the transverse-sectional shape of the root hole 23b of the through hole 23 includes a circular part G1 and an extended part G2. Note that in accordance with the fact that the extension direction of the inner terminal 50 accommodated in the through hole 23 is assumed to be in the X direction, the extension direction of the through hole 23 is also assumed to be along the X direction. In this case, the transverse section of the through hole 23 is represented by the YZ plane defined by the Y direction and the Z direction which are perpendicular to the X direction and perpendicular to each other.

The circular part G1 is defined by a maximum cross-sectional radius r. The maximum cross-sectional radius r is the same as that defined in the first embodiment as illustrated in FIG. 5. The circular part G1 includes a semicircular part 23c which forms an actual part of the through hole 23 and a virtual semicircular part which is symmetrical in the Z-direction with the semicircular part 23c. Note that in FIG. 8, the virtual semicircular part which defines the circular part G1 is drawn as a two-dot chain line. As illustrated in FIG. 8, the size of the circular part G1 may be one size larger than that of the transverse section of the root hole 23b illustrated in FIG. 5.

The extended part G2 extends from the circular part G1 in one direction crossing the parallel direction of the two through holes 23. In the present embodiment, the parallel direction of the two through holes 23 is the Y direction. Since the transverse section of the through holes 23 is on the YZ plane, one direction crossing the parallel direction of the two through holes 23 is the Z direction orthogonal to the Y direction. Note that the direction in which the extended part G2 is extended from the circular part G1 is not limited to a direction orthogonal to the Y direction, and a slight inclination from the direction orthogonal to the Y direction is allowed.

In the present embodiment, the extended part G2 includes two side parts 23e opposed each other in the parallel direction of the two through holes 23, and an upper part 23d facing the semicircular part 23c in the direction orthogonal to the parallel direction. The upper part 23d is a linear side part approximately along the parallel direction. One side part 23e of the two side parts 23e is a linear side part coupling one end part of the semicircular part 23c and one end part of the upper part 23d along the direction in which the semicircular part 23c and the upper part 23d face each other. Similarly, the other side part 23e of the two side parts 23e is a linear side part coupling the other end part of the semicircular part 23c and the other end part of the upper part 23d along the direction in which the semicircular part 23c and the upper part 23d face each other. Note that the side part 23e and the upper part 23d are not limited to those formed by a perfect straight line, and a part or the entirety thereof may be formed by a slight curve, or may include a minute step.

That is, since the transverse-sectional shape of the through hole 23 includes the circular part G1 and the extended part G2, it can be said that the through hole 23 is a through part surrounded by an inner peripheral wall constituted by the semicircular part 23c, two side wall parts constituted by the side parts 23e, and an upper wall part constituted by the upper part 23d.

In this manner, in the connector 1 according to the third embodiment, the transverse-sectional shape of the part where the joining part 52 is accommodated in the through hole 23 may include the circular part G1 defined by the maximum cross-sectional radius r and the extended part G2. The extended part G2 may be a part extended from the circular part G1 in one direction crossing the parallel direction of the two through holes 23.

Here, in the above example, the parallel direction of the two through holes 23 corresponds to the Y direction. In this case, in the transverse section of the through holes 23, one direction crossing the parallel direction of the two through holes 23 corresponds to the Z direction.

In the second embodiment described above, the transverse-sectional shape of the root hole 23b of the through holes 23 accommodating the joining part 52 is a circle defined by the maximum cross-sectional radius r. Thus, the size of the first side wall part 52b and the second side wall part 52c provided in the joining part 52 is also not set to exceed the range of the circular transverse section of the root hole 23b.

In contrast, in the present embodiment, the through hole 23 accommodating the joining part 52 includes not only a region in which the transverse-sectional shape is specified as the circular part G1 but also a region in which the transverse-sectional shape is specified as the extended part G2. Here, the direction in which the extended part G2 is continuous with respect to the circular part G1 is along the direction in which the first side wall part 52b and the second side wall part 52c provided in the joining part 52 project from the bottom wall part 52a. Thus, as illustrated in FIG. 8, the tip parts 52g of the first side wall part 52b and the second side wall part 52c can be located in the region specified by the extended part G2 beyond the region specified by the circular part G1. That is, the value of the maximum height t from the bottom wall part 52a to the tip part 52g of the first side wall part 52b or the second side wall part 52c specified in the third embodiment can be larger than in the second embodiment. Therefore, in the connector 1 according to the present embodiment, by setting the value of the maximum height t to a larger value, it is possible to further suppress the increase in impedance and further improve transmission performance.

For example, as illustrated in FIG. 8, the value of the maximum height t may be set to the value when the tip parts 52g of the first side wall part 52b and the second side wall part 52c are close to and facing the upper part 23d in the direction orthogonal to the parallel direction of the two through holes 23. In this case, the value of the maximum height t is set to the largest among possible values in the through hole 23 formed with a certain size, and thus higher transmission performance can be obtained.

### Fourth Embodiment

The second embodiment exemplifies the case where the joining part 52 in the inner terminal 50 includes the first side wall part 52b and the second side wall part 52c in addition to the bottom wall part 52a. In this case, the shape of the bottom wall part 52a is a flat plate. In contrast, a connector 1 according to the fourth embodiment adopts an inner terminal 60 in which the shape of the bottom wall part 52a is modified while the joining part includes side wall parts equivalent to the first side wall 52b and the like.

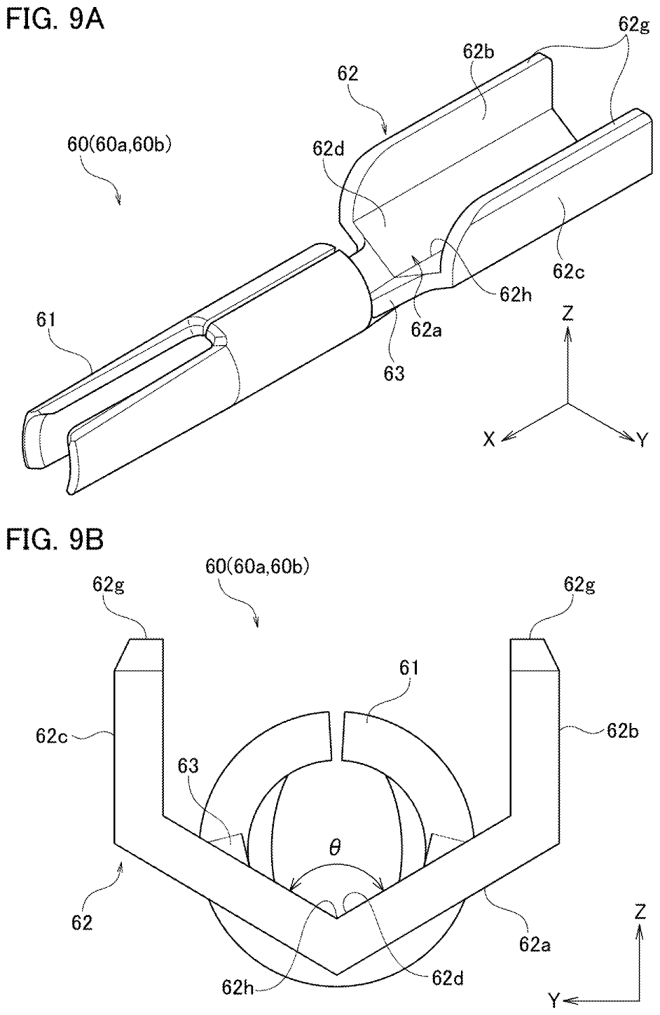

FIGS. 9A and 9B are diagrams illustrating the inner terminal 60 according to the fourth embodiment. FIG. 9A is a perspective view of the inner terminal 60. FIG. 9B is a back view of the inner terminal 60 when the side of a joining part 62 is viewed along the extension direction of the inner terminal 60.

As in the second embodiment, in the connector 1 according to the present embodiment, there are two inner terminals 60, a first terminal 60a and a second terminal 60b, having the same shape. The inner terminal 60 includes a connecting part 61, the joining part 62, and a coupling part 63. In the inner terminal 60, the shape of the joining part 62 and the shape of the coupling part 63 associated with the shape of the joining part 62 differ from those of the joining part 52 and the coupling part 53 in the second embodiment. The shape of the connecting part 61 is the same as that of the connecting part 51 in the second embodiment.

The joining part 62 includes a bottom wall part 62a, a first side wall part 62b, and a second side wall part 62c.

In the bottom wall part 62a, a bending line 62h along the extension direction corresponding to the X direction is set in advance on the side of a joining surface 62d. The bottom wall part 62a is a V-shaped plate part which is bent symmetrically with respect to the bending line 62h and has a V-shaped cross-sectional shape. A bending angle θ at the joining surface 62d is obtuse and may be, for example, 120°.

The first side wall part 62b and the second side wall part 62c project from both ends in the width direction, corresponding to the Y direction, of the bottom wall part 62a toward the side where the joining surface 62d is opened. The first side wall part 62b and the second side wall part 62c are symmetrical with respect to the bottom wall part 62a and parallel to each other. That is, in the present embodiment, the first side wall part 62b and the second side wall part 62c are flat plates of the same shape and are opposed each other in the width direction.

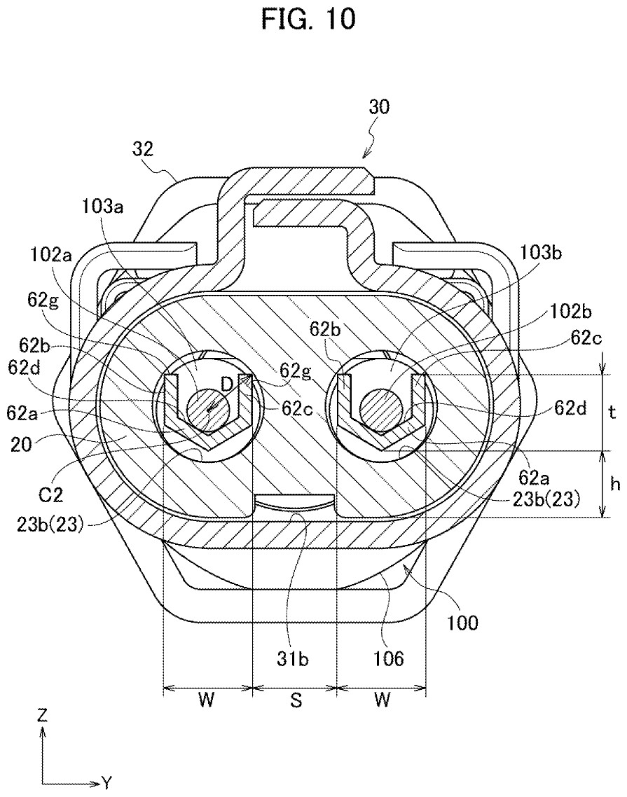

FIG. 10 is a cross-sectional view of the connector 1 according to the fourth embodiment, which is cut in a transverse section where a first core wire 102a and a second core wire 102b each joined to either one of the joining parts 62 of the inner terminals 60 are present. Note that FIG. 10 is drawn corresponding to FIG. 7 regarding the second embodiment. In the fourth embodiment, elements corresponding to the elements used in the description of the second embodiment are denoted by the same reference numerals, and the detailed description thereof may be omitted as appropriate.

In the present embodiment, the height of the joining part 62 in the height direction can be regarded as the maximum height t from the lower end of the bottom wall part 62a to a tip part 62g of the first side wall part 62b or the second side wall part 62c. Note that the thicknesses in the width direction of the first side wall part 62b and the second side wall part 62c may be each equal to, for example, the thickness of the bottom wall part 62a.

As in the above embodiments, for example, the distance from the center C2 of the first core wire 102a to the maximum distance part which is the farthest from the first core wire 102a at the joining part 62 can be defined as a distance D. In the present embodiment, the maximum distance part is a part of the tip part 62g. The width W of the bottom wall part 62a is set larger than the dimension value of the width W when the distance D and the cross-sectional radius r of the root hole 23b are the same value.

In this manner, in the connector 1 according to the fourth embodiment, the joining part 62 may include two flat-plate side wall parts which are symmetrical with respect to the bottom wall part 62a and parallel to each other. The bottom wall part 62a may be a V-shaped plate part which is bent symmetrically with respect to the bending line 62h along the extension direction in such a manner that the bending angle θ at the joining surface 62d is obtuse, and has a V-shaped cross-sectional shape. The two side wall parts may project from both ends in the width direction of the bottom wall part 62a toward the side where the joining surface 62d is opened.

Here, the two side wall parts included in the joining part 62 correspond to the first side wall part 62b and the second side wall part 62c in the above example.

Since the joining part 62 of the inner terminal 60 has the first side wall part 62b and the second side wall part 62c in addition to the bottom wall part 62a, the connector 1 according to the fourth embodiment has the same effect as the connector 1 according to the second embodiment.

Further, since the bottom wall part 62a of the joining part 62 is a V-shaped plate part, even when an electric wire 100 has a tendency to bend or the first core wire 102a and the like are frayed, the first core wire 102a and the like are appropriately positioned at the stage of being mounted on the joining surface 62d of the joining part 62. Thus, for example, before joining the first core wire 102a, various steps such as correcting the fraying of the first core wire 102a, detecting the joining position using a camera, and correcting the position on the joining object side or the joining machine side are unnecessary. Therefore, the work efficiency can be improved by suppressing the increase in work time or work cost for joining the first core wire 102a and the like.

Note that also in the present embodiment, the maximum height t in the height direction of the joining part 62 may be set to the maximum value to the extent that the accommodation of the joining part 62 in the through hole 23 is permitted.

In this connector 1, the value of the maximum height t of the joining part 62 is set to the largest value that can be set in the structure, thereby achieving higher transmission performance.

Also in the present embodiment, in the extension direction of the inner terminal 60 as the terminal metal fitting, the length L of the side wall parts may be the same as the length of the bottom wall part 62a.

In this connector 1, the side wall parts can be set larger at the joining part 62, and the shape of the terminal metal fitting can be easily maintained constant when the terminal metal fitting is manufactured, which can be advantageous to stabilize the impedance value for each manufactured terminal metal fitting.

Meanwhile, the inner terminal 60 may be modified as an inner terminal 70 described below.

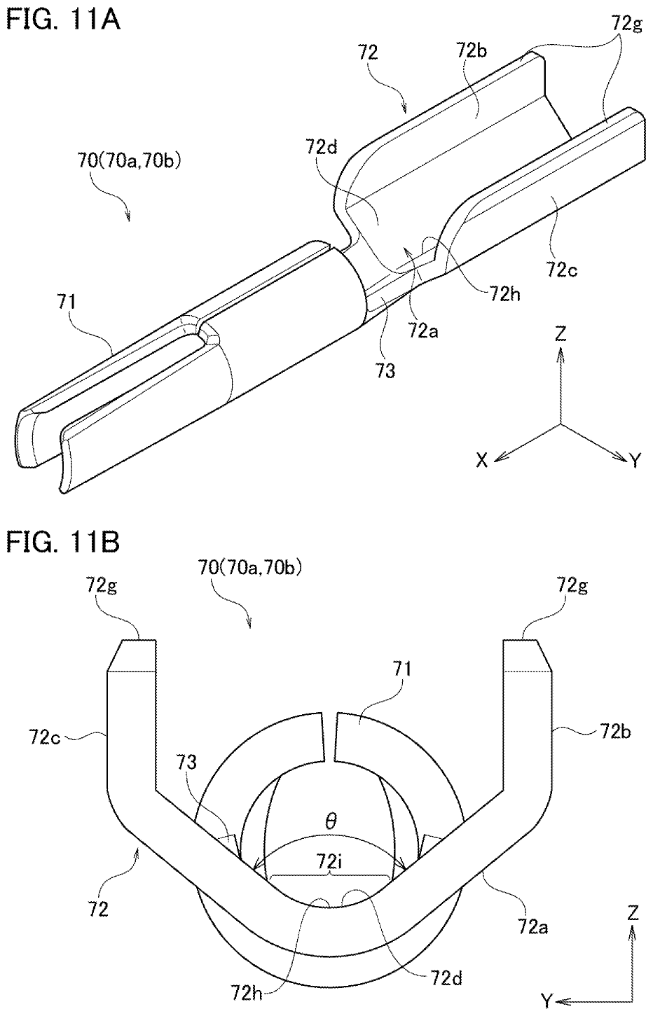

FIGS. 11A and 11B illustrate an inner terminal 70 as an example of another inner terminal according to the fourth embodiment. FIG. 11A is a perspective view of the inner terminal 70. FIG. 11B is a back view of the inner terminal 70 when the side of a joining part 72 is viewed along the extension direction of the inner terminal 70.

In this case, in the connector 1 according to the present embodiment, there are two inner terminals 70, a first terminal 70a and a second terminal 70b, having the same shape. The inner terminal 70 includes a connecting part 71, the joining part 72, and a coupling part 73. In the inner terminal 70, the shape of the joining part 72 and the shape of the coupling part 73 associated with the shape of the joining part 72 differ from those of the joining part 62 and the coupling part 63 in the inner terminal 60. The shape of the connecting part 71 is the same as that of the connecting part 61 in the inner terminal 60.

The joining part 72 has a bottom wall part 72a, a first side wall part 72b, and a second side wall part 72c.

In the bottom wall part 72a, a bending line 72h along the extension direction corresponding to the X direction is set in advance on the side of a joining surface 72d. The bottom wall part 72a is a V-shaped plate part which is bent symmetrically with respect to the bending line 72h and has a V-shaped cross-sectional shape. The bending angle θ at the joining surface 72d is obtuse and may be, for example, 120°.

The first side wall part 72b and the second side wall part 72c project from both ends in the width direction, corresponding to the Y direction, of the bottom wall part 72a toward the side where the joining surface 72d is opened. The first side wall part 72b and the second side wall part 72c are symmetrical with respect to the bottom wall part 72a and parallel to each other. That is, in the present embodiment, the first side wall part 72b and the second side wall part 72c are flat plates of the same shape and are opposed each other in the width direction.

In the present embodiment, the height of the joining part 72 in the height direction can be regarded as the maximum height t from the lower end of the bottom wall part 72a to a tip part 72g of the first side wall part 72b or the second side wall part 72c. Note that the thicknesses in the width direction of the first side wall part 72b and the second side wall part 72c may be each equal to, for example, the thickness of the bottom wall part 72a.

Here, in the inner terminal 70, the joining surface 72d may include a curved surface 72i having a symmetrical shape with respect to the bending line 72h while including the bending line 72h.

The connector 1 adopting the inner terminal 70 has the same effect as the connector 1 adopting the inner terminal 60. Further, with the connector 1 adopting the inner terminal 70, for example, when the first core wire 102a is mounted on the joining surface 72d of the joining part 72, a gap space between the first core wire 102a and the curved surface 72i becomes narrow. Thus, when the first core wire 102a is joined to the joining part 72 using welding, the fit between the first core wire 102a and the joining part 72 can be improved, and consequently, decrease in shear tensile strength can be suppressed.

### Fifth Embodiment

The third embodiment exemplifies the case where the transverse-sectional shape of the root hole 23b of the through hole 23 has the extended part G2 in the inner housing 20 and thus the value of the maximum height t is set larger in the joining part 52 of the inner terminal 50. In contrast, the connector 1 according to the fifth embodiment adopts an inner terminal 80 in which the shape of the bottom wall part 52a of the joining part 52 is further modified in order to correspond to the shape of the inner housing 20 in the third embodiment.

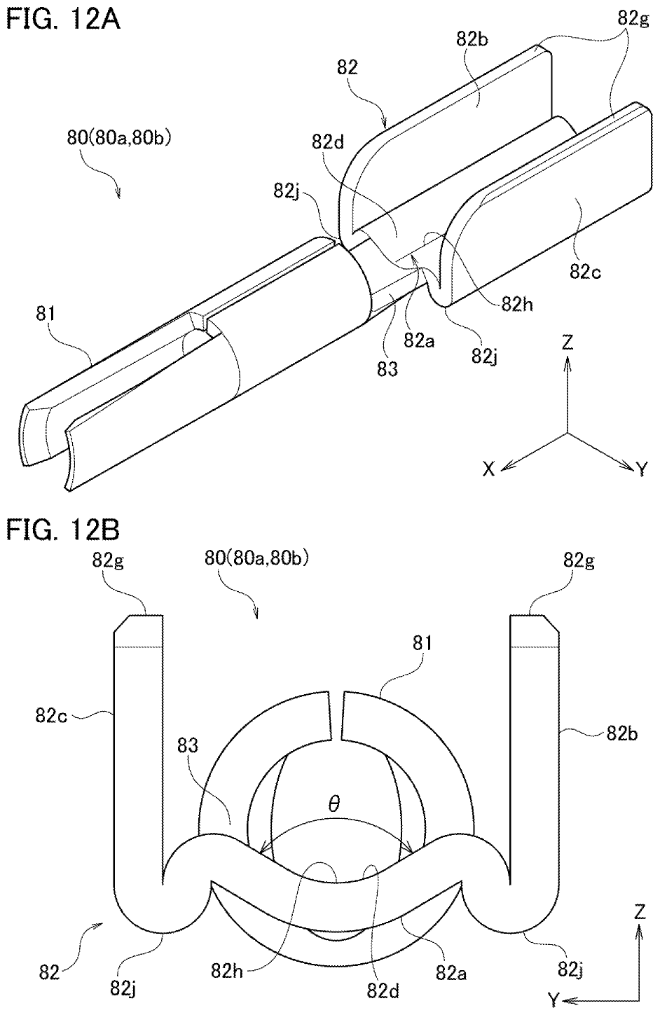

FIGS. 12A and 12B are diagrams illustrating the inner terminal 80 according to the fifth embodiment. FIG. 12A is a perspective view of the inner terminal 80. FIG. 12B is a back view of the inner terminal 80 when the side of a joining part 82 is viewed along the extension direction of the inner terminal 80.

As in the third embodiment, in the connector 1 according to the present embodiment, there are two inner terminals 80, a first terminal 80a and a second terminal 80b, having the same shape. The inner terminal 80 includes a connecting part 81, the joining part 82, and a coupling part 83. In the inner terminal 80, the shape of the joining part 82 and the shape of the coupling part 83 associated with the shape of the joining part 82 differ from those of the joining part 52 and the coupling part 53 in the third embodiment. The shape of the connecting part 81 is the same as that of the connecting part 51 in the third embodiment.

The joining part 82 includes a bottom wall part 82a, a first side wall part 82b, and a second side wall part 82c.

In the bottom wall part 82a, a bending line 82h along the extension direction corresponding to the X direction is set in advance on the side of a joining surface 82d. The bottom wall part 82a is a bent part which is bent symmetrically with respect to the bending line 82h. The bending angle θ at the joining surface 82d is obtuse and may be, for example, 120°.

The first side wall part 82b and the second side wall part 82c project via folding parts 82j from both ends in the width direction, corresponding to the Y direction, of the bottom wall part 82a toward the side where the joining surface 82d is opened. The folding parts 82j each bend from the bottom wall part 82a in a direction in which a convex shape of the bottom wall part 82a is directed, and then fold back the first side wall part 82b and the like to the opposite side. Here, the direction in which the convex shape of the bottom wall part 82a is directed is a direction toward the opposite side of the Z direction. In contrast, the direction of the first side wall part 82b and the like folded back via the folding parts 82j is a direction along the Z direction. In the height direction corresponding to the Z direction, the lower ends of the folding parts 82j may be at positions equivalent to the lower ends of the bottom wall part 82a. The first side wall part 82b and the second side wall part 82c are symmetrical with respect to the bottom wall part 82a and parallel to each other. That is, also in the present embodiment, the first side wall part 82b and the second side wall part 82c are flat plates of the same shape and are opposed each other in the width direction.

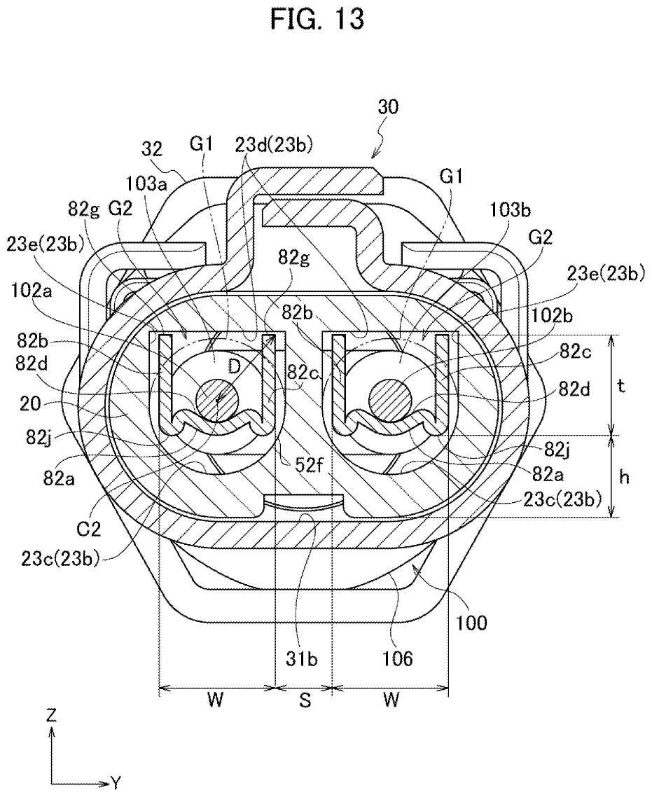

FIG. 13 is a cross-sectional view of the connector 1 according to the fifth embodiment, which is cut in a transverse section where a first core wire 102a and a second core wire 102b each joined to either one of the joining parts 82 of the inner terminals 80 are present. Note that FIG. 13 is drawn corresponding to FIG. 8 regarding the third embodiment. In the fifth embodiment, elements corresponding to the elements used in the description of the third embodiment are denoted by the same reference numerals, and the detailed description thereof may be omitted as appropriate.

In the present embodiment, the height of the joining part 82 in the height direction can be regarded as the maximum height t from the lower end of the bottom wall part 82a or the folding part 82j to a tip part 82g of the first side wall part 82b or the second side wall part 82c. Note that the thicknesses in the width direction of the first side wall part 82b and the second side wall part 82c may be equal to, for example, the thickness of the bottom wall part 82a.

As in the above embodiments, for example, the distance from the center C2 of the first core wire 102a to the maximum distance part which is the farthest from the first core wire 102a at the joining part 82 can be defined as a distance D. In the present embodiment, the maximum distance part is a part of the tip part 82g. The width W of the bottom wall part 82a is set larger than the dimension value of the width W when the distance D and the cross-sectional radius r of the root hole 23b are the same value.

In this manner, in the connector 1 according to the fifth embodiment, the joining part 82 may include two flat-plate side wall parts which are symmetrical with respect to the bottom wall part 82a and parallel to each other. The bottom wall part 82a may be a bent part which is bent symmetrically with respect to the bending line 82h along the extension direction in such a manner that the bending angle θ at the joining surface 82d is obtuse. The two side wall parts may project via the folding parts 82j from both ends in the width direction of the bottom wall part 82a toward the side where the joining surface 82d is opened.

Here, the two side wall parts included in the joining part 82 correspond to the first side wall part 82b and the second side wall part 82c in the above example.

Since the joining part 82 of the inner terminal 80 has the first side wall part 82b and the second side wall part 82c in addition to the bottom wall part 82a, the connector 1 according to the fifth embodiment has the same effect as the connector 1 according to the third embodiment.

Further, since the bottom wall part 82a of the joining part 82 is a bent part including a curved surface similar to the curved surface 72i of the bottom wall part 72a of the joining part 72 of the inner terminal 70 in the fourth embodiment, the effect is equivalent to that of the connector 1 adopting the inner terminal 70.

Note that also in the present embodiment, the maximum height t of the joining part 82 in the height direction may be set to the maximum value to the extent that the accommodation of the joining part 82 in the through hole 23 is permitted.

In this connector 1, the value of the maximum height t of the joining part 82 is set to the largest value that can be set in the structure, thereby achieving higher transmission performance.

Also in the present embodiment, in the extension direction of the inner terminal 80 as the terminal metal fitting, the length L of the side wall parts may be the same as the length of the bottom wall part 82a.

In this connector 1, the side wall parts can be set larger at the joining part 82, and the shape of the terminal metal fitting can be easily maintained constant when the terminal metal fitting is manufactured, which can be advantageous to stabilize the impedance value for each manufactured terminal metal fitting.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
two terminal metal fittings each including a joining part for joining either one of core wires of two wires included in one electric wire; and
an insulating member including two parallel through holes for accommodating the two terminal metal fittings one by one in a same orientation, wherein
the joining part includes at least a bottom wall part that has a plate shape and includes a joining surface for joining the core wire thereto while in contact with a side part of the core wire,
a width of the bottom wall part in a width direction orthogonal to an extension direction of the terminal metal fitting is set larger than a dimension value of the width when a distance from a center of the core wire to a maximum distance part which is the farthest from the core wire at the joining part, and a maximum cross-sectional radius of the through hole are a same value, and
the core wire is joined to the joining surface using laser welding or laser soldering.

2. The connector according to claim 1, wherein the bottom wall part is a flat plate part.

3. The connector according to claim 2, wherein the width of the bottom wall part is set to a maximum value to the extent that accommodation of the joining part in the through hole is permitted.

4. The connector according to claim 2, wherein the joining part includes two side wall parts each having a flat plate shape and projecting from both ends in the width direction of the bottom wall part in a height direction perpendicular to the joining surface.

5. The connector according to claim 4, wherein a maximum height of the joining part in the height direction is set to a maximum value to the extent that accommodation of the joining part in the through hole is permitted.

6. The connector according to claim 4, wherein in the extension direction of the terminal metal fitting, a length of the side wall part is the same as a length of the bottom wall part.

7. The connector according to claim 4, wherein
a transverse-sectional shape of a part of the through hole where the joining part is accommodated includes:
a circular part defined by the maximum cross-sectional radius; and
an extended part extended from the circular part in one direction crossing a parallel direction of the two through holes.

8. The connector according to claim 1, wherein
the joining part includes two side wall parts that have a flat plate shape, and are symmetrical to each other with respect to the bottom wall part and parallel to each other,
the bottom wall part is a V-shaped plate part that is bent symmetrically with respect to a bending line along the extension direction in such a manner that a bending angle at the joining surface is obtuse, and has a V-shaped cross-sectional shape, and
the two side wall parts project from both ends in the width direction of the bottom wall part toward a side where the joining surface is opened.

9. The connector according to claim 8, wherein the joining surface includes a curved surface having a symmetrical shape with respect to the bending line while including the bending line.

10. The connector according to claim 1, wherein
the joining part includes two side wall parts that have a flat plate shape, and are symmetrical to each other with respect to the bottom wall part and parallel to each other,
the bottom wall part is a bent part that is bent symmetrically with respect to a bending line along the extension direction in such a manner that a bending angle at the joining surface is obtuse, and
the two side wall parts project via a folding part from both ends in the width direction of the bottom wall part toward a side where the joining surface is opened.
